(19) United States
(12) Patent Application Publication
(10) Pub. No.: US 2026/0326352 A1
(43) Pub. Date: Oct. 22, 2026

(54) DIE EJECTOR HAVING INDEPENDENTLY ENGAGED EJECTOR RODS, METHOD OF PERFORMING DIE PICK-UP WITH THE DIE EJECTOR, AND DIE EJECTOR SYSTEM INCLUDING THE DIE EJECTOR

(71) Applicant: Taiwan Semiconductor Manufacturing Company Limited, Hsinchu (TW)

(72) Inventors: Chih-Yuan Chiu, Zhudong Township (TW); Chi-Chun Peng, Hsinchu (TW); Yu-Hong Du, Hsinchu (TW); Wei-ting Hsiao, Taichung City (TW); Amram Eitan, Hsinchu (TW)

(21) Appl. No.: 19/720,995

(22) Filed: Jun. 26, 2026

Related U.S. Application Data
(62) Division of application No. 18/675,189, filed on May 28, 2024.

(51) Int. Cl. B29C 45/40

(52) U.S. Cl. CPC B29C 45/401; B29C 2045/4021

(57) ABSTRACT

A die ejector may include an ejector cap, an ejector holder in the ejector cap, a plurality of ejector rods in the ejector holder, wherein the plurality of ejector rods are independently engaged, and a plurality of ejector pins on the plurality of ejector rods. A method of performing die pick-up may include placing a semiconductor die on a die ejector including a plurality of ejector rods and a plurality of ejector pins on the plurality of ejector rods, wherein the plurality of ejector rods are independently engaged, generating an ejector rod configuration so that the plurality of ejector pins have a configuration based on the semiconductor die, advancing the plurality of ejector rods based on the ejector rod configuration so that the plurality of ejector pins contact the semiconductor die, and lifting the semiconductor die off the plurality of ejector pins.

### CROSS-REFERENCE TO RELATED APPLICATIONS

This application is a divisional of or relates to U.S. Application No. 18/675,189 entitled “Die Ejector Having Independently Engaged Ejector Rods, Method of Performing Die Pick-Up with the Die Ejector, and Die Ejector System Including the Die Ejector,” filed May 28, 2024, which is hereby incorporated by reference in its entirety for all purposes.

### BACKGROUND

In a semiconductor device manufacturing process, a plurality of semiconductor chips may be formed simultaneously on a semiconductor wafer. An adhesive tape may be attached to a bottom of the semiconductor wafer. The wafer may then be singulated by dicing while attached to the adhesive tape so that the singulated dies remain in the form of an array on the adhesive tape. A pickup process may then be performed by an electromechanical pick-and-place (PNP) machine to pick up the singulated dies from off the adhesive tape.

In the pickup process, a die ejector may be used to help separate a die from the adhesive tape. The die ejector may include one or more ejector pins. The die may be placed over the die ejector. The die ejector may then push the ejector pins upward so that the ejector pins break through the adhesive tape and contact a bottom of the die. The ejector pins may then apply an upward force on the bottom of the die to remove it from the adhesive tape.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1A is a vertical cross-sectional view of the die ejector in a pickup process according to one or more embodiments.

FIG. 1B is an exploded view of the ejector rods in the die ejector according to one or more embodiments.

FIG. 1C is a detailed view of an ejector pin in the die ejector according to one or more embodiments.

FIG. 1D is a top-down view of the ejector pins in the die ejector according to one or more embodiments.

FIG. 1E is a vertical cross-sectional view of the die ejector illustrating various dimensions of the die ejector according to one or more embodiments.

FIG. 2A illustrates a first configuration (e.g., Rod 1/2/3 configuration) of the ejector rods according to one or more embodiments.

FIG. 2B illustrates a second configuration (e.g., Rod 1/2 configuration) of the ejector rods according to one or more embodiments.

FIG. 2C illustrates a third configuration (e.g., Rod 1 configuration) of the ejector rods according to one or more embodiments.

FIG. 2D illustrates a fourth configuration (e.g., Rod 2/3 configuration) of the ejector rods according to one or more embodiments.

FIG. 2E illustrates a fifth configuration (e.g., Rod 2 configuration) of the ejector rods according to one or more embodiments.

FIG. 3A is a vertical cross-sectional view of the die ejector at a first stage in the pickup process according to one or more embodiments.

FIG. 3B is a vertical cross-sectional view of the die ejector at a second stage in the pickup process according to one or more embodiments.

FIG. 3C is a vertical cross-sectional view of the die ejector at a third stage in the pickup process according to one or more embodiments.

FIG. 3D is a vertical cross-sectional view of the die ejector at a fourth stage in the pickup process according to one or more embodiments.

FIG. 4 is a flowchart illustrating a method of performing die pick-up according to one or more embodiments.

FIG. 5 is a vertical cross-sectional view of the die ejector having a first alternative configuration according to one or more embodiments.

FIG. 6A illustrates a first configuration of the ejector rods according to one or more embodiments.

FIG. 6B illustrates a second configuration of the ejector rods according to one or more embodiments.

FIG. 6C illustrates a third configuration of the ejector rods according to one or more embodiments.

FIG. 6D illustrates a fourth configuration of the ejector rods according to one or more embodiments.

FIG. 6E illustrates a fifth configuration of the ejector rods according to one or more embodiments.

FIG. 6F illustrates a sixth configuration of the ejector rods according to one or more embodiments.

FIG. 7A is a perspective view of the die ejector with the second alternative configuration according to one or more embodiments.

FIG. 7B is an exploded view of the ejector rods in the die ejector with a second alternative configuration according to one or more embodiments.

FIG. 7C is a top-down view of the ejector pins in the die ejector with a second alternative configuration according to one or more embodiments.

FIG. 8A is a top-down view of the ejector pins having a first layout in the die ejector with the second alternative configuration according to one or more embodiments.

FIG. 8B is a top-down view of the ejector pins having a second layout in the die ejector with the second alternative configuration according to one or more embodiments.

FIG. 8C is a top-down view of the ejector pins having a third layout in the die ejector with the second alternative configuration according to one or more embodiments.

FIG. 8D is a top-down view of the ejector pins having a fourth layout in the die ejector with the second alternative configuration according to one or more embodiments.

FIG. 8E is a top-down view of the ejector pins having a fifth layout in the die ejector with the second alternative configuration according to one or more embodiments.

FIG. 8F is a top-down view of the ejector pins having a sixth layout in the die ejector with the second alternative configuration according to one or more embodiments.

FIG. 9A is a top-down view of the outer rod base plate top portion, intermediate rod base plate and inner rod proximal end having a first alternative configuration according to one or more embodiments.

FIG. 9B is a top-down view of the outer rod base plate top portion, intermediate rod base plate and inner rod proximal end having a second alternative configuration according to one or more embodiments.

FIG. 10 is a schematic drawing of the drive mechanism for driving the ejector rods in the die ejector according to one or more embodiments.

FIG. 11 is a schematic drawing of the inner rod linear actuator in the drive mechanism in the die ejector according to one or more embodiments.

FIG. 12 is a schematic drawing of the drive mechanism having an alternative configuration in the die ejector according to one or more embodiments.

FIG. 13 is a schematic block diagram of a die ejecting system according to one or more embodiments.

### DETAILED DESCRIPTION

The following disclosure provides many different embodiments, or examples, for implementing different features of the invention. Specific embodiments or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Detaching a die from an adhesive tape without damaging the die may be challenging when the thickness of the die is small (e.g., below about 100 microns). There are various forms of ejector pin designs for facilitating detachment of a die from an adhesive tape to which the die is mounted. The simplest form of ejector pin design is a single ejector pin design, which is a traditional design for detaching a small die from an adhesive tape. As the size of the die gets bigger (say, more than 4×4 mm), multiple ejector pins may instead be used for detaching the die from the adhesive tape.

Current multiple ejector pin assemblies may include one or more ejector pins mounted on a pin holder having one or more stages. The target die attached on an adhesive tape may be positioned to the center of a vacuum enclosure which contains the ejector pin assembly. Before the ejector pins move up to push against the die through the deformable adhesive tape, vacuum suction may be applied within the vacuum enclosure. The suction may hold the adhesive tape down onto the top platform of the vacuum enclosure via the negative pressure exerted through the vacuum holes on the platform. The adhesive tape carrying the die may lie flat on top of the platform under compression by atmospheric pressure. The ejector pins may then elevate from below and rise above the top surface of the platform, such that the ejector pins will push the die up and induce a bending moment on the die in order to separate the adhesive tape from the die.

In the related multiple ejector pin assemblies, localized stress from the ejector pins acting on the die can be quite high. In some instances, the push-up action of the ejector pins may induce relatively large deformations on the die at the locations right above the pins. The push up action may cause die crack failure in instance in which the induced strain exceeds a critical value.

Further, advanced semiconductor packaging processes may combine hybrid bonding and pick-and-place (PNP) die bonding technology. As production requirements become increasingly diverse, it may be important for equipment to be suitable for various product sizes. Currently, semiconductor processing equipment may include a single layout for original ejector during a semiconductor die pick-up process. Consequently, a tool conversion may be implemented for different products and, thereby result in wasted equipment availability time.

One or more embodiments of the present disclosure may include a die ejector that may be used in a semiconductor die pick-up process and bonding process. The die may have a variable configuration (e.g., multiple layout). In particular, a configuration of the die ejector may be varied depending on a configuration of the semiconductor die that is the target of a PNP process. In at least one embodiment, the die ejector may include a plurality of rods or rod sets that may be independently controlled. As a result, various embodiments disclosed herein may not require a tool conversion for different products. Thus, one or more embodiments may help to ensure that semiconductor processing equipment is suitable for a variety of products may be used in the absence of a tool conversion.

One or more embodiments may, therefore, improve a tool conversion ratio to achieve a reduction in tool changeover times for multi-layer production. The one or more embodiments may also help to ensure that the dies (e.g., especially thin dies) are free of chipping defects in a die stacking process.

Various embodiments die ejectors may each include several novel features. The die ejector may include a new ejector structure design for multiple product production. The die ejector may include a controllable multiple layout ejector. The die ejector may also provide for multiple layouts in one ejector.

Several advantages/benefits may be provided by the various embodiment die ejectors. In particular, the various embodiment die ejectors may improve equipment available time. The die ejector may also provide an improved process window. The die ejector may also help to reduce a number of void defects, and therefore may also provide improved reliability and product yield.

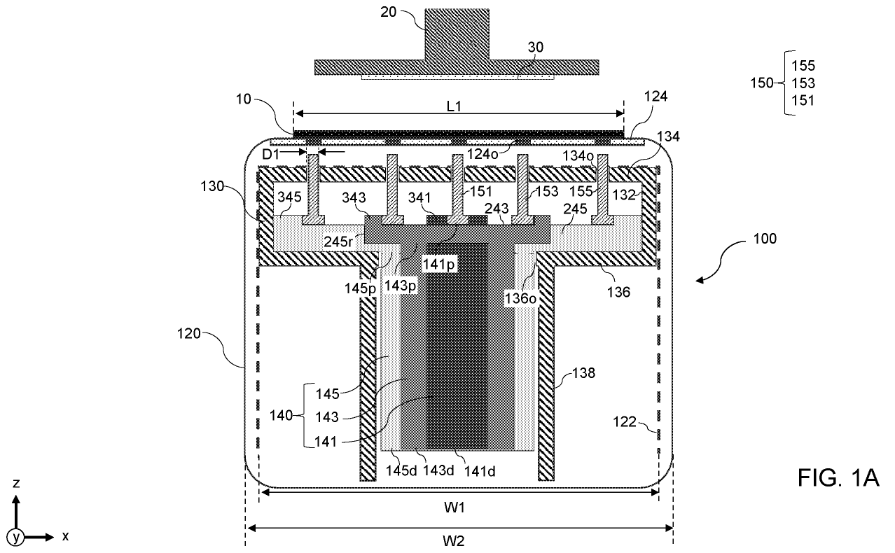

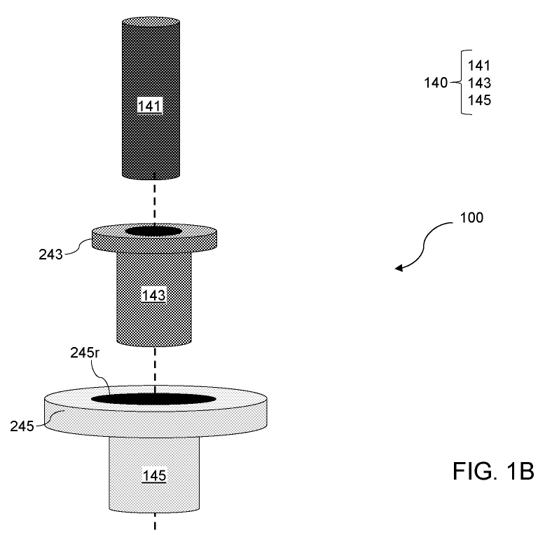

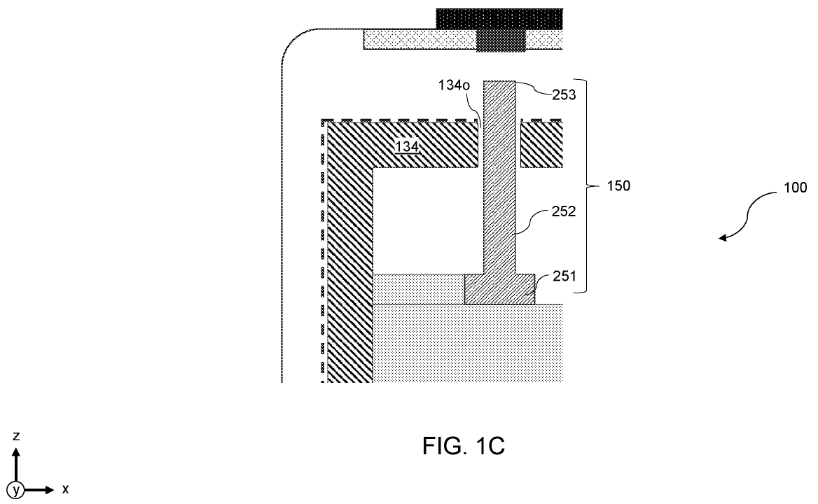

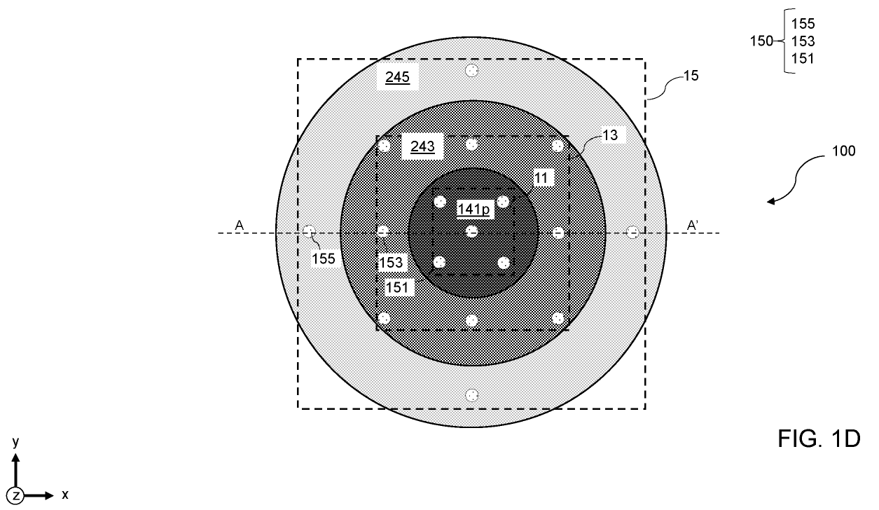

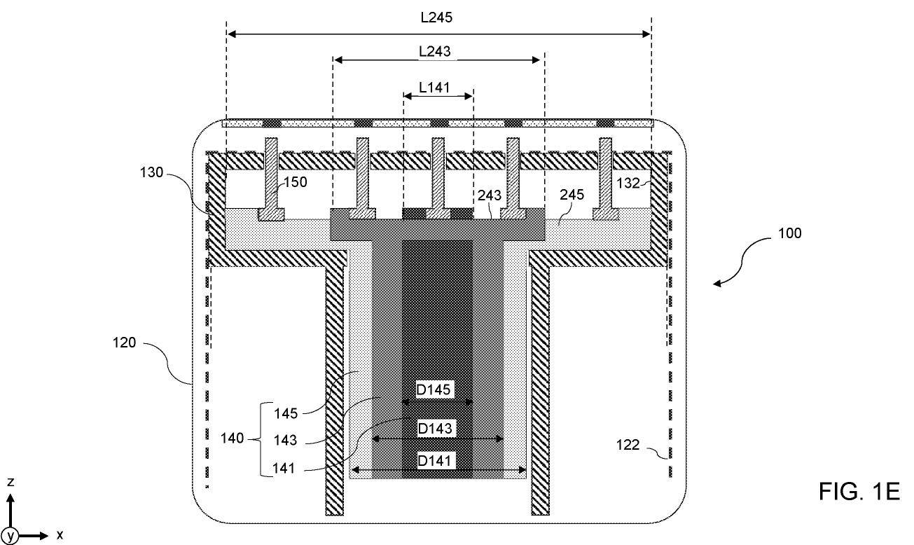

FIGS. 1A-1C are various views of a die ejector 100 according to one or more embodiments. In particular, FIG. 1A is a vertical cross-sectional view of the die ejector 100 in a pickup process according to one or more embodiments. FIG. 1B is an exploded view of the ejector rods 140 in the die ejector 100 according to one or more embodiments. FIG. 1C is a detailed view of an ejector pin 150 in the die ejector 100 according to one or more embodiments. FIG. 1D is a top-down view of the ejector pins 150 in the die ejector 100 according to one or more embodiments. The vertical cross-sectional view in FIG. 1A is along A-A’ in FIG. 1D. FIG. 1E is a vertical cross-sectional view of the die ejector 100 illustrating various dimensions of the die ejector 100 according to one or more embodiments.

The die ejector 100 may be used in a semiconductor die pick-up process and bonding process. In the semiconductor die pickup process, a semiconductor die 10 may be placed over the die ejector 100. The semiconductor die 10 may be adhered to an adhesive tape (not shown). A tip holder 20 of an electromechanical PNP machine may be located over the semiconductor die 10.

The tip holder 20 may be lowered onto the semiconductor die 10 so that a rubber tip 30 on the tip holder 20 contacts an upper surface of the semiconductor die 10. The die ejector 100 may then force the semiconductor die 10 upward and may cause the semiconductor die 10 to be detached from the adhesive tape. A vacuum may then be applied through the tip holder 20 to the upper surface of the semiconductor die 10 so that the semiconductor die 10 is attached to the tip holder 20 by the vacuum. Thus, with the aid of the die ejector 100, the tip holder 20 may pickup the semiconductor die 10 from off the adhesive tape and then the PNP machine may move the tip holder 20 with the semiconductor die 10 attached thereto to a location specified in a die bonding process.

As illustrated in FIG. 1A, the die ejector 100 may include an ejector cap 120. The ejector cap 120 may be formed of a metal, ceramic or hard plastic material. Other materials are within the contemplated scope of disclosure. The ejector cap 120 may have a substantially cuboid shape, square cylindrical shape or circular cylindrical shape. Other shapes are within the contemplated scope of disclosure. The ejector cap 120 may have a hollow interior bounded by an ejector cap inner sidewall 122. The ejector cap 120 may also include an ejector cap top plate 124 including a plurality of ejector cap openings 124o disposed therein. The ejector cap top plate 124 may serve as a support surface for the semiconductor die 10 during a pickup process.

The die ejector 100 may also include an ejector holder 130 in the ejector cap 120. The ejector holder 130 may slidably contact the ejector cap inner sidewall 122. The ejector holder 130 may be movable back and forth in the z-direction within the ejector cap 120. The ejector holder 130 may also be formed of a metal, ceramic or hard plastic material. Other suitable materials are within the contemplated scope of disclosure. The ejector holder 130 may also have a substantially cuboid shape, square cylindrical shape or circular cylindrical shape. Other shapes are within the contemplated scope of disclosure. The ejector holder 130 may also have a hollow interior bounded by an ejector holder inner sidewall 132.

The ejector holder 130 may also include an ejector holder top plate 134 including a plurality of ejector holder openings 134o. The plurality of ejector holder openings 134o may be substantially aligned in the z-direction with the ejector cap openings 124o. The ejector holder top plate 134 may be removably attached (e.g., threadedly attached) to a body of the ejector holder 130. The ejector holder 130 may also include an ejector holder bottom plate 136 opposite the ejector holder top plate 134. The ejector holder bottom plate 136 including an opening 136o in a central region of the ejector holder bottom plate 136.

The ejector holder 130 may also include a shaft 138. The shaft 138 may be connected to the ejector holder bottom plate 136. An end of the shaft 138 that is opposite the ejector holder bottom plate 136 may be connected to an ejector holder movement mechanism (not shown). The ejector holder movement mechanism may push and pull on the shaft 138 to move the ejector holder 130 back and forth in the z-direction.

The die ejector 100 may also include a plurality of ejector rods 140. The plurality of ejector rods 140 may be independently configurable. The plurality of ejector rods 140 may be concentrically arranged in the ejector cap 120.

The plurality of ejector rods 140 may include an inner rod 141. The inner rod 141 may have, for example, a solid cylindrical shape. The plurality of ejector rods 140 may also include an outer rod 145 around the inner rod 141, and an intermediate rod 143 between the inner rod 141 and the outer rod 145. Each of the inner rod 141 and outer rod 145 may have a hollow cylindrical shape. The intermediate rod 143 may slidably contact the inner rod 141 and the outer rod 145. The outer rod 145 may slidably contact the ejector holder bottom plate 136 around the opening 136o.

The inner rod 141, intermediate rod 143 and outer rod 145 may include an inner rod proximal end 141p, intermediate rod proximal end 143p, and outer rod proximal end 145p, respectively. The inner rod proximal end 141p, intermediate rod proximal end 143p, and outer rod proximal end 145p may be located adjacent (e.g., inside) the ejector holder 130.

The inner rod 141, intermediate rod 143 and outer rod 145 may also include an inner rod distal end 141d, intermediate rod distal end 143d, and outer rod distal end 145d, respectively. The inner rod distal end 141d, intermediate rod distal end 143d, and outer rod distal end 145d may be located opposite the inner rod proximal end 141p, intermediate rod proximal end 143p, and outer rod proximal end 145p, respectively.

An outer rod base plate 245 may be attached to the outer rod proximal end 145p. The outer rod base plate 245 may slidably contact the ejector holder inner sidewall 132. The outer rod base plate 245 may have a substantially annular shape. The outer rod base plate 245 may be concentrically arranged with the outer rod 145. The outer rod base plate 245 may be seated on the ejector holder bottom plate 136. The outer rod base plate 245 may include a recessed portion 245r concentrically arranged with the outer rod 145 and the outer rod base plate 245.

An intermediate rod base plate 243 may be attached to the intermediate rod proximal end 143p. The intermediate rod base plate 243 may be configured to be nested in the recessed portion 245r of the outer rod base plate 245 (e.g., see FIG. 1B). The intermediate rod base plate 243 may slidably contact a sidewall of the recessed portion 245r of the outer rod base plate 245. The intermediate rod base plate 243 may be configured to move freely into and out of the recessed portion 245r of the outer rod base plate 245. The intermediate rod base plate 243 may also have a substantially annular shape. The intermediate rod base plate 243 may also be concentrically arranged with the intermediate rod 143.

The die ejector 100 may also include one or more ejector pins 150 at the proximal ends of the ejector rods 140. The one or more ejector pins 150 may be formed of a metal or metal material (e.g., copper, aluminum, steel, etc.) or ceramic material. Other suitable materials are within the contemplated scope of disclosure. With reference to FIG. 1C, the ejector pins 150 may include an ejector pin base 251, ejector pin main body 252 and ejector pin tip 253 (see FIG. 1C). The ejector pin base 251 may be attached to a mounting surface by a weld, threaded attachment, etc. The ejector pin main body 252 may be integrally formed with the ejector pin base 251. The ejector pin main body 252 may have a cylindrical shape (e.g., circular cylinder shape, square cylinder shape, etc.). The ejector pin main body 252 may extend through an ejector holder opening 134o in the ejector holder top plate 134. In at least one embodiment, the ejector pin main body 252 may extend through the ejector holder opening 134o in both an engaged and a disengaged configuration. The ejector pin tip 253 may include a flat shape, rounded shape, triangular shape, etc. Other shapes are within the contemplated scope of disclosure. The one or more ejector pins 150 may be arranged in an ejector pin layout on the inner rod proximal end 141p, an upper surface of the intermediate rod base plate 243 and an upper surface of the outer rod base plate 245 (see FIG. 1D). The ejector pin layout may allow the die ejector 100 to accommodate a large size die 15, intermediate size die 13 and small size die 11 in a pickup process. It should be noted that the inner rod proximal end 141p, the intermediate rod base plate 243 and the outer rod base plate 245 may have any shape that accommodates the ejector pin layout, such as a circular outer shape, rectangular outer shape, square outer shape, oval outer shape, etc.

Referring again to FIG. 1A, the ejector pins 150 may include a plurality of inner ejector pins 151 attached to the inner rod proximal end 141p. One or more inner rod pin support structures 341 may also be attached to the inner rod proximal end 141p. The one or more inner rod pin support structures 341 may support the plurality of inner ejector pins 151 on the inner rod proximal end 141p. The one or more inner rod pin support structures 341 may have an annular shape and be concentrically arranged with the inner rod proximal end 141p. In some embodiments, the one or more inner rod pin support structures 341 may be integrally formed with the inner rod proximal end 141p. In other embodiments, the one or more inner rod pin support structures 341 may also be attached to the inner rod proximal end 141p by a weld, threaded attachment, etc.

The ejector pins 150 may include a plurality of intermediate ejector pins 153 attached to an upper surface of the intermediate rod base plate 243. The plurality of intermediate ejector pins 153 may be attached to the upper surface of the intermediate rod base plate 243 by a weld, threaded attachment, etc. One or more intermediate rod pin support structures 343 may also be attached to the upper surface of the intermediate rod base plate 243. The one or more intermediate rod pin support structures 343 may support the plurality of intermediate ejector pins 153 on the upper surface of the intermediate rod base plate 243. The one or more intermediate rod pin support structures 343 may have an annular shape and be concentrically arranged with the intermediate rod base plate 243. The one or more intermediate rod pin support structures 343 may be integrally formed with the intermediate rod base plate 243. The one or more intermediate rod pin support structures 343 may also be attached to the upper surface of the intermediate rod base plate 243 by a weld, threaded attachment, etc.

The ejector pins 150 may include a plurality of outer ejector pins 155 attached to an upper surface of the outer rod base plate 245. The plurality of outer ejector pins 155 may be attached to the outer rod base plate 245 by a weld, threaded attachment, etc. One or more outer rod pin support structures 345 may also be attached to the upper surface of the outer rod base plate 245. The one or more outer rod pin support structures 345 may support the plurality of outer ejector pins 155 on the upper surface of the outer rod base plate 245. The one or more outer rod pin support structures 345 may have an annular shape and be concentrically arranged with the outer rod base plate 245. The one or more outer rod pin support structures 345 may be integrally formed with the outer rod base plate 245. The one or more outer rod pin support structures 345 may also be attached to the upper surface of the outer rod base plate 245 by a weld, threaded attachment, etc.

The ejector pins 150 may be arranged on the inner rod proximal end 141p, the upper surface of the intermediate rod base plate 243 and the upper surface of the outer rod base plate 245 so as to be substantially aligned in the z-direction with the plurality of ejector holder openings 134o and with the plurality of ejector cap openings 124o. The ejector holder openings 134o may include one or more ejector holder inner openings configured to receive the plurality of inner ejector pins 151, one or more ejector holder intermediate openings configured to receive the plurality of intermediate ejector pins 153, and one or more ejector holder outer openings configured to receive the plurality of outer ejector pins 155. The ejector cap openings 124o may include one or more ejector cap inner openings configured to receive the plurality of inner ejector pins 151, one or more ejector cap intermediate openings configured to receive the plurality of intermediate ejector pins 153, and one or more ejector cap outer openings configured to receive the plurality of outer ejector pins 155.

As illustrated in FIG. 1A, the ejector pins 150 (e.g., ejector pin main body 252; see FIG. 1C) may have a diameter D1 (e.g., width in the x-direction) greater than or equal to about 0.1mm. The semiconductor die 10 that is to be the target of a pickup process may have a length L1 in the x-direction greater than the diameter D1 of the ejector pins 150. The ejector holder 130 may have a width W1 in the x-direction that is substantially the same as a distance between the inner sidewalls 122 of the ejector cap 120. The width W1 of the ejector holder 130 may be greater than the length L1 of the semiconductor die 10. The ejector cap 120 may have a width W2 in the x-direction that is greater than the width W1 of the ejector holder 130.

The inner rod distal end 141d, intermediate rod distal end 143d, and outer rod distal end 145d may be attached to an ejector rod movement mechanism (not shown). During a die pickup process, the ejector rod movement mechanism may independently advance one or more of the inner rod 141, intermediate rod 143 or the outer rod 145. In particular, the ejector rod movement mechanism may independently advance one or more of the inner rod 141, intermediate rod 143 or the outer rod 145 based on a characteristic of the semiconductor die 10 that is the target of the die pickup process.

Referring again to FIG. 1E, the inner rod 141 may have a diameter D141 in the x-direction. The intermediate rod 143 may have a diameter D143 greater than diameter D141 in the x-direction. The outer rod 145 may have a diameter D145 greater than diameter D143 in the x-direction.

The inner rod 141 may have a length L141 in the x-direction. In at least one embodiment, the length L141 of the inner rod 141 may be substantially the same as the diameter D141 of the inner rod. In at least one embodiment, the length L141 of the inner rod 141 may be made greater than a diameter D141 of the inner rod 141. In particular, an inner rod base plate (not shown) may be attached to the inner rod proximal end 141p. In that case, the length L141 of the inner rod 141 (e.g., length of the inner rod base plate in the x-direction) may be greater than the diameter D141 of the inner rod 141.

The intermediate rod base plate 243 may have a length L243 greater than the length L141 of the inner rod 141 in the x-direction. The length L243 of the intermediate rod base plate 243 may be greater than the diameter D143 of the intermediate rod 143. In at least one embodiment, the intermediate rod base plate 243 may be omitted in which case diameter D143 of the intermediate rod 143 may be substituted for the length L243.

The outer rod base plate 245 may have a length L245 greater than the length L243 of the intermediate rod base plate 243 in the x-direction. The width W1 of the ejector holder 130 may be greater than the length L245 of the outer rod base plate 245 (see FIG. 1A). The length L245 of the outer rod base plate 245 may be greater than the diameter D145 of the outer rod 145. In at least one embodiment, the outer rod base plate 245 may be omitted in which case diameter D145 of the outer rod 145 may be substituted for the length L245.

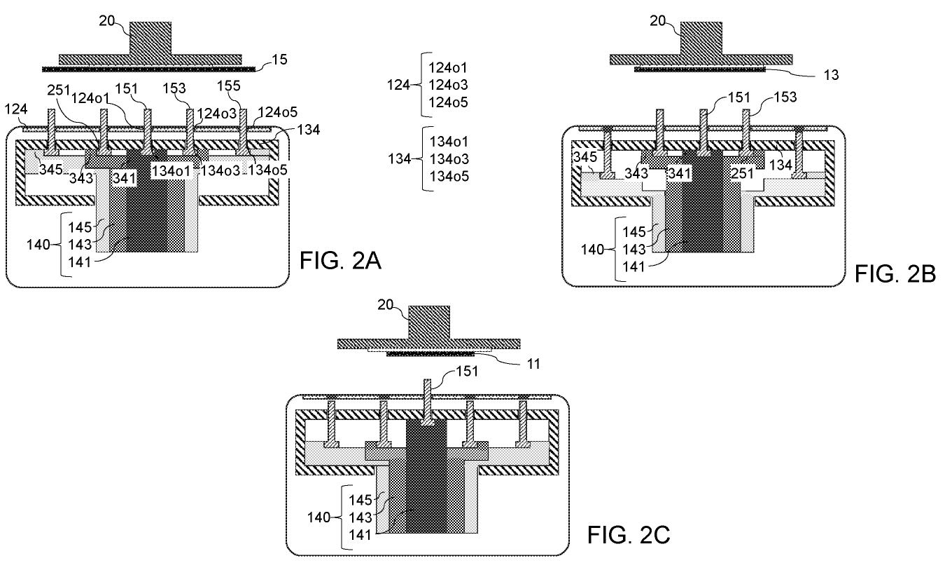

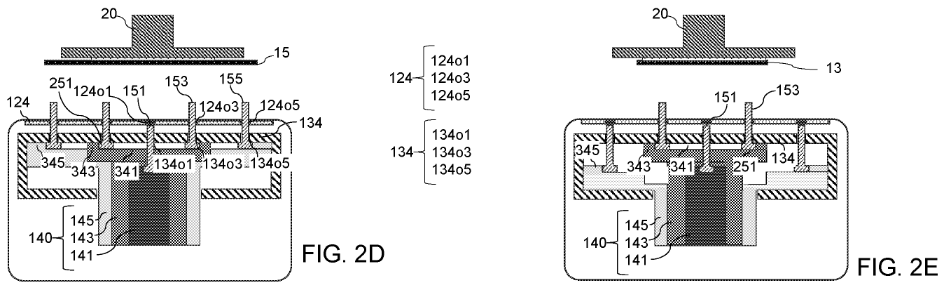

FIGS. 2A-2C illustrate various configurations of the ejector rods 140 according to one or more embodiments. In particular, FIG. 2A illustrates a first configuration (e.g., Rod 1/2/3 configuration) of the ejector rods 140 according to one or more embodiments. As illustrated in FIG. 2A, in the first configuration, the inner rod 141, intermediate rod 143 and outer rod 145 are all driven up by the die ejector 100 so and into an engaged status. As a result, the plurality of inner ejector pins 151, plurality of intermediate ejector pins 153 and plurality of outer ejector pins 155 may contact a bottom surface of the semiconductor die 10 (see FIG. 1A) in a pickup process. This configuration may provide an ejector pin layout for accommodating a large size die 15 in a pickup process (see FIG. 1D).

As illustrated in FIG. 2A, in the first configuration (e.g., Rod 1/2/3 configuration), the ejector holder inner openings 134o1 may be configured to receive the plurality of inner ejector pins 151, the ejector holder intermediate openings 134o3 may be configured to receive the plurality of intermediate ejector pins 153, and the ejector holder outer openings 134o5 may be configured to receive the plurality of outer ejector pins 155. Further, the ejector cap inner openings 124o1 may be configured to receive the plurality of inner ejector pins 151, the ejector cap intermediate openings 124o3 may be configured to receive the plurality of intermediate ejector pins 153, and the ejector cap outer openings 124o5 may be configured to receive the plurality of outer ejector pins 155.

It should be noted that each of the inner rod 141, intermediate rod 143 and outer rod 145 may have a partial engagement status that is between an engaged status (e.g., fully engaged status) and a disengaged status. The partial engagement status may also be measured, for example, in percentages of the rod’s total drive distance between engaged status and disengaged status. Thus, for example, if the drive distance between engaged status and disengaged status for the inner rod 141 is 5 mm and the inner rod 141 is driven only 4.5 mm, then the inner rod 141 may be in a 90% engaged status (e.g., partial engagement status). By allowing for partial engagement status, the die ejector 100 may provide an infinite number of configurations of the ejector rods 140.

As further illustrated in FIG. 2A, in the engaged status, the inner rod pin support structures 341, the intermediate rod pin support structures 343 and outer rod pin support structures 345 may contact a bottom surface of the ejector holder top plate 134. The ejector pin base 251 of the ejector pins 150 may have the same height as the inner rod pin support structure 341, intermediate rod pin support structures 343 and outer rod pin support structure 345. Therefore, the ejector pin base 251 may also contact the bottom surface of the ejector holder top plate 134 in an engaged status.

FIG. 2B illustrates a second configuration (e.g., Rod 1/2 configuration) of the ejector rods 140 according to one or more embodiments. As illustrated in FIG. 2B, in the second configuration, the inner rod 141 and intermediate rod 143 are all driven up and into an engaged status by the die ejector 100. The outer rod 145, however, is not driven by the die ejector 100 and remains in a disengaged status. As a result, the plurality of inner ejector pins 151 and plurality of intermediate ejector pins 153 may contact a bottom surface of the semiconductor die 10 (see FIG. 1A) in a pickup process. This configuration may provide an ejector pin layout for accommodating an intermediate size die 13 in a pickup process (see FIG. 1D).

FIG. 2C illustrates a third configuration (e.g., Rod 1 configuration) of the ejector rods 140 according to one or more embodiments. As illustrated in FIG. 2C, in the third configuration, the inner rod 141 is driven up and into an engaged status by the die ejector 100. The intermediate rod 143 and outer rod 145, however, are not driven by the die ejector 100 and may remain in a disengaged status. As a result, the plurality of inner ejector pins 151 may contact a bottom surface of the semiconductor die 10 (see FIG. 1A) in a pickup process. This configuration may provide an ejector pin layout for accommodating a small size die 11 in a pickup process.

FIG. 2D illustrates a fourth configuration (e.g., Rod 2/3 configuration) of the ejector rods 140 according to one or more embodiments. As illustrated in FIG. 2D, in the fourth configuration, the intermediate rod 143 and the outer rod 145 are in an engaged status, but the inner rod 141 is in a disengaged status. As a result, the plurality of intermediate ejector pins 153 and outer ejector pins 155 may contact a bottom surface of the semiconductor die 10 (see FIG. 1A) in a pickup process.

FIG. 2E illustrates a fifth configuration (e.g., Rod 2 configuration) of the ejector rods 140 according to one or more embodiments. As illustrated in FIG. 2E, in the fifth configuration, the intermediate rod 143 is in an engaged status, but the inner rod 141 and outer rod 145 are in a disengaged status. As a result, the plurality of intermediate ejector pins 153 may contact a bottom surface of the semiconductor die 10 (see FIG. 1A) in a pickup process.

One of skill in the art may recognize that additional configurations may be achieved with additional ejector rods 140 engaging additional ejector pins 150.

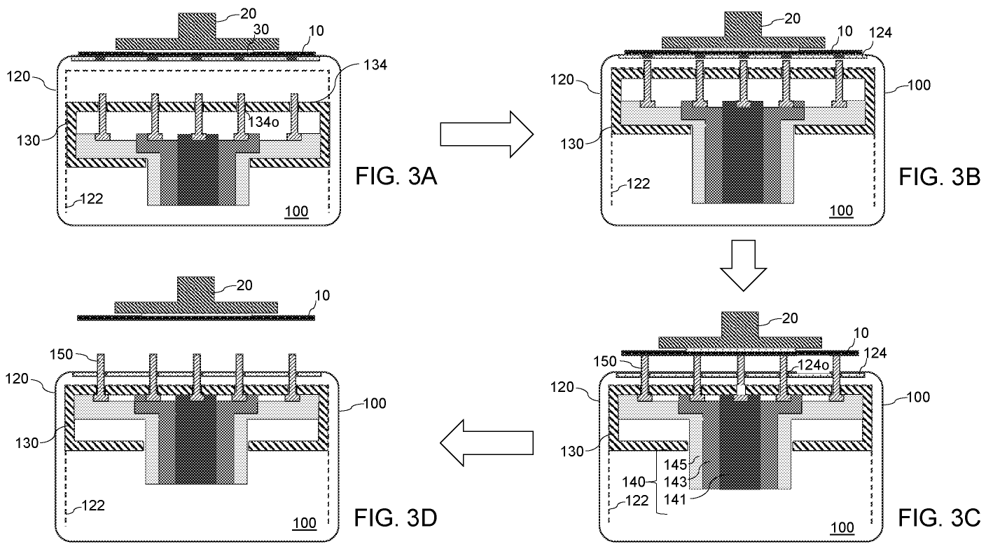

FIGS. 3A-3C are vertical cross-sectional views of the die ejector 100 at various stages in a die pickup process according to one or more embodiments. In particular, FIG. 3A is a vertical cross-sectional view of the die ejector 100 at a first stage in the pickup process according to one or more embodiments. As illustrated in FIG. 3A, in the first stage, the semiconductor die 10 may be located on the die ejector 100. The semiconductor die 10 may be placed on the die ejector 100 while adhered to an adhesive tape (not shown). The tip holder 20 (e.g., part of an electromechanical PNP machine) may then be lowered onto the semiconductor die 10 so that the tip 30 (e.g., rubber tip disposed on the tip holder 20) contacts the semiconductor die 10.

FIG. 3B is a vertical cross-sectional view of the die ejector 100 at a second stage in the pickup process according to one or more embodiments. As illustrated in FIG. 3B, in the second stage, the die ejector 100 may advance the ejector holder 130 upward in the ejector cap 120 toward the semiconductor die 10. The ejector holder 130 may slide upward along the inner sidewalls 122 of the ejector cap 120.

FIG. 3C is a vertical cross-sectional view of the die ejector 100 at a third stage in the pickup process according to one or more embodiments. At some point prior to the third stage, the die ejector 100 may generate an ejector rod configuration so that the ejector pins 150 have a configuration based on a characteristic of the semiconductor die 10. The die ejector 100 may generate the ejector rod configuration by detecting a characteristic (e.g., size, shape, weight, height, etc.) of the semiconductor die 10, and then generating the ejector rod configuration based on the characteristic of the semiconductor die 10. The die ejector 100 may detect the characteristic of the semiconductor die 10, for example, by detecting a size of the semiconductor die 10 with a camera, detecting a shape of the semiconductor die 10 with a camera, inputting at least one of a size or shape of the semiconductor die 10 by a user, etc.

As illustrated in FIG. 3C, in the third stage, the die ejector 100 may engage at least one of the inner rod 141, intermediate rod 143 or outer rod 145 based on the generated ejector rod configuration. As the inner rod 141, intermediate rod 143 and/or outer rod 145 are advanced upward, the ejector pins 150 may be pushed through the ejector cap openings 124o in the ejector cap top plate 124. In particular, the ejector pins 150 may be caused to protrude out of the ejector cap openings 124o in the ejector cap top plate 124 and contact the semiconductor die 10. This may force the semiconductor die 10 upward and may cause the semiconductor die 10 to be detached from the adhesive tape (not shown). A vacuum may then be applied by the electromechanical PNP machine through the tip holder 20 to the upper surface of the semiconductor die 10 so that the semiconductor die 10 is attached to the tip holder 20 by the vacuum.

FIG. 3D is a vertical cross-sectional view of the die ejector 100 at a fourth stage in the pickup process according to one or more embodiments. As illustrated in FIG. 3D, in the fourth stage, the semiconductor die 10 may be lifted off of the ejector pins 150 with the tip holder 20. Thus, with the aid of the die ejector 100, the tip holder 20 may pickup the semiconductor die 10 from off the adhesive tape and then the PNP machine may move the tip holder 20 with the semiconductor die 10 to a location specified in a fabrication (e.g., die bonding) process.

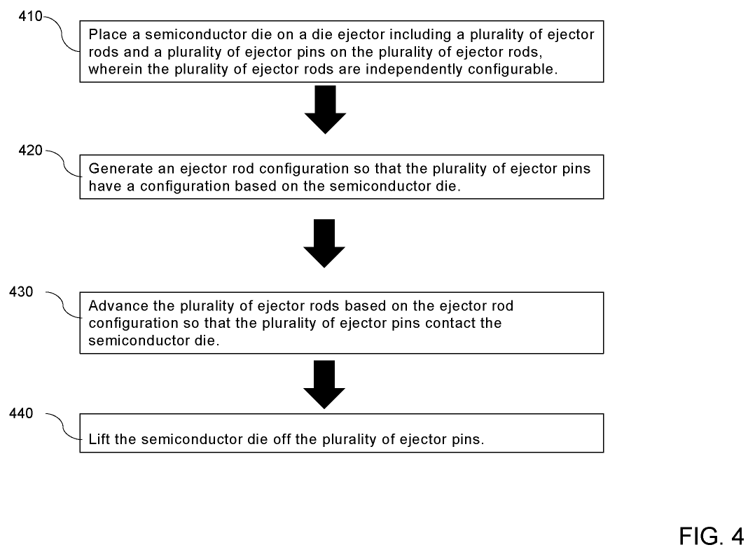

FIG. 4 is a flowchart illustrating a method of performing die pick-up according to one or more embodiments. Step 410 may include placing a semiconductor die 10 on a die ejector 100 including a plurality of ejector rods 140 and a plurality of ejector pins 150 on the plurality of ejector rods 140, wherein the plurality of ejector rods 140 (141, 143, 145) are independently configurable. Step 420 may include generating an ejector rod 140 configuration so that the plurality of ejector pins 150 have a configuration based on the specific parameters of the semiconductor die 10. Step 430 may include advancing the plurality of ejector rods 140 based on the ejector rod configuration so that the plurality of ejector pins 150 contact the semiconductor die 10. Step 440 may include lifting the semiconductor die 10 off the plurality of ejector pins 150.

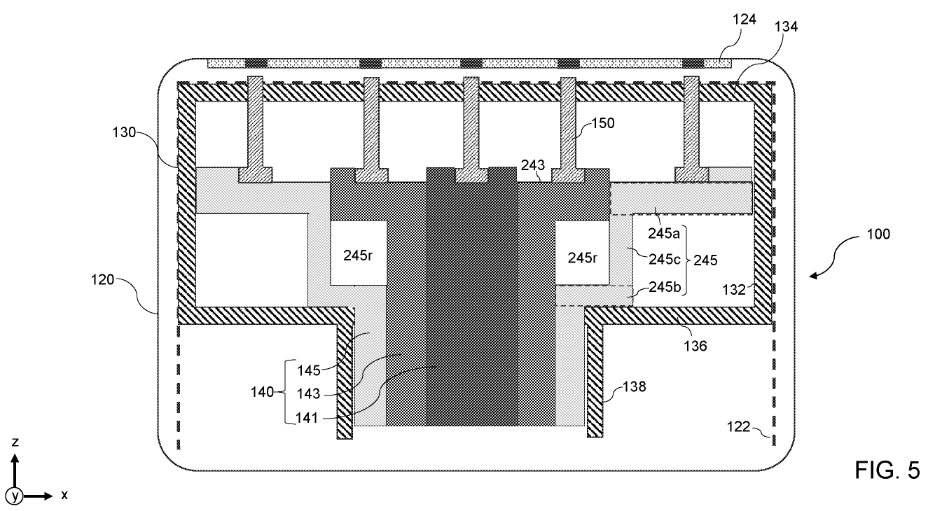

FIG. 5 is a vertical cross-sectional view of the die ejector 100 having a first alternative configuration according to one or more embodiments. As illustrated in FIG. 5, the die ejector 100 having the first alternative configuration may be substantially the same as the configuration in FIG. 1A. In particular, the inner rod 141 and intermediate rod 143 may be substantially the same as in the configuration of FIG. 1A. The ejector cap 120 and ejector pins 150 may be substantially the same as in the configuration of FIG. 1A.

However, a first alternative configuration may be different from the configuration in FIG. 1A in at least two respects. First, the outer rod base plate 245 may have a stepped configuration including an outer rod base plate top portion 245a, an outer rod base plate bottom portion 245b and an outer rod base plate connecting portion 245c connecting the outer rod base plate top portion 245a and outer rod base plate bottom portion 245b. With this configuration a depth of the recessed portion 245r in the outer rod base plate 245 may be greater than the depth of the recessed portion 245r in the configuration of FIG. 1A. In particular, the recessed portion 245r may extend beneath the bottom surface of the outer rod base plate top portion 245a. The deeper recessed portion 245r in the first alternative configuration may allow the outer rod 145 to be independently advanced into an engaged status while the intermediate rod 143 remains in a disengaged status.

Second, a length of the ejector holder 130 in the z-direction may be greater than in the configuration of FIG. 1A in order to accommodate the outer rod base plate 245 with a deeper recessed portion 245r. In particular, a distance in the z-direction between the ejector holder bottom plate 136 and the ejector holder top plate 134 may be greater than in the configuration in FIG. 1A.

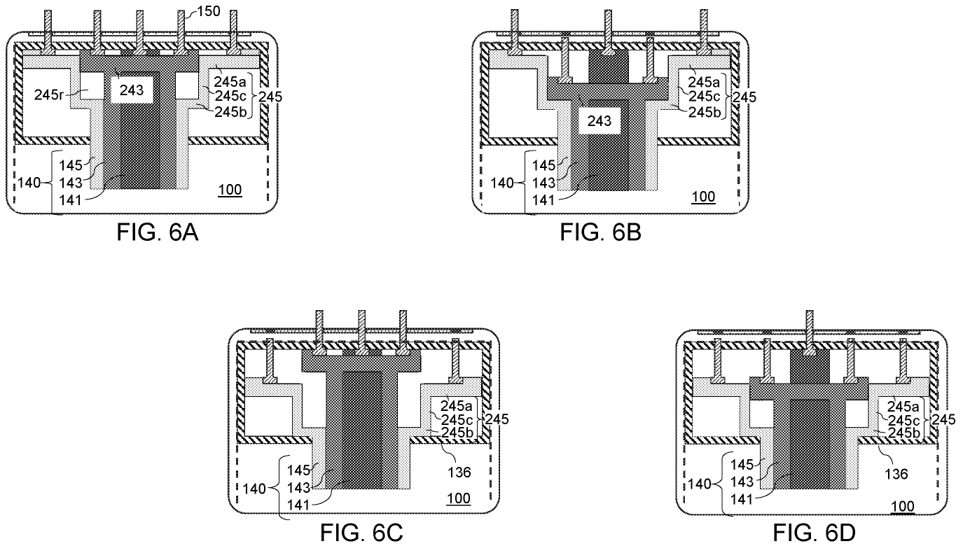

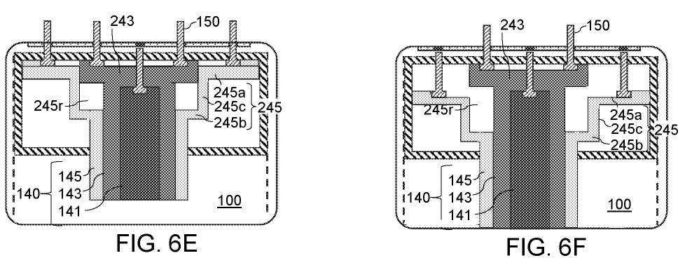

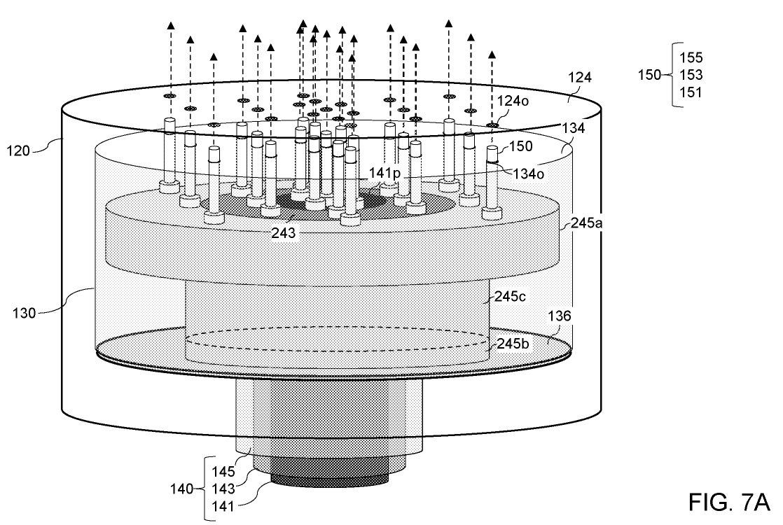

FIGS. 6A-6D are vertical cross-sectional views of the die ejector 100 with the first alternative configuration having various ejector rod configurations according to one or more embodiments. In particular, FIG. 6A illustrates a first configuration of the ejector rods 140 according to one or more embodiments. As illustrated in FIG. 6A, in the first configuration, the inner rod 141, intermediate rod 143 and outer rod 145 are all driven up and into an engaged status by the die ejector 100.

FIG. 6B illustrates a second configuration of the ejector rods 140 according to one or more embodiments. As illustrated in FIG. 6B, in the second configuration, the inner rod 141 and outer rod 145 are driven up and into an engaged status by the die ejector 100. The intermediate rod 143 is not driven by the die ejector 100 and remains in a disengaged status. In particular, the intermediate rod 143 seated on the outer rod base plate bottom portion 245b in the recessed portion 245r.

FIG. 6C illustrates a third configuration of the ejector rods 140 according to one or more embodiments. As illustrated in FIG. 6C, in the third configuration, the inner rod 141 and intermediate rod 143 are driven up and into an engaged status by the die ejector 100. The outer rod 145 is not driven by the die ejector 100 and remains in a disengaged status. In particular, the outer rod base plate bottom portion 245b may be seated on the ejector holder bottom plate 136 in this configuration.

FIG. 6D illustrates a fourth configuration of the ejector rods 140 according to one or more embodiments. As illustrated in FIG. 6D, in the fourth configuration, the inner rod 141 is driven up and into an engaged status by the die ejector 100. The intermediate rod 143 and the outer rod 145 are not driven by the die ejector 100 and remain in a disengaged status. The outer rod base plate bottom portion 245b is again seated on the ejector holder bottom plate 136 in this configuration.

FIG. 6E illustrates a fifth configuration of the ejector rods 140 according to one or more embodiments. As illustrated in FIG. 6E, in the fifth configuration, the intermediate rod 143 and the outer rod 145 are in an engaged status, but the inner rod 141 is in a disengaged status.

FIG. 6F illustrates a sixth configuration of the ejector rods 140 according to one or more embodiments. As illustrated in FIG. 6F, in the sixth configuration, the intermediate rod 143 is in an engaged status, but the inner rod 141 and outer rod 145 are in a disengaged status.

One of skill in the art may recognize that additional configurations may be achieved with additional ejector rods 140 engaging additional ejector pins 150.

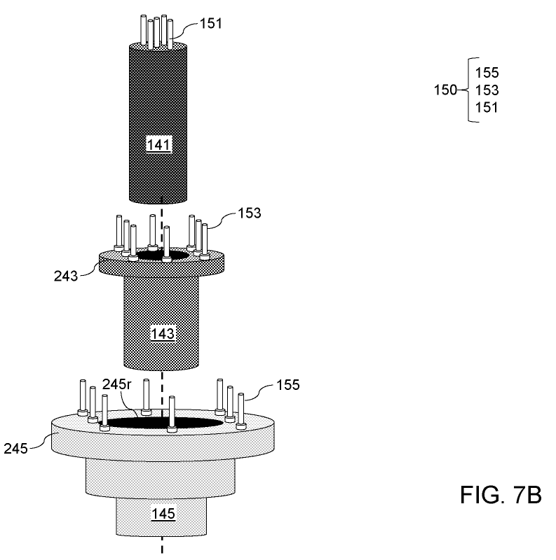

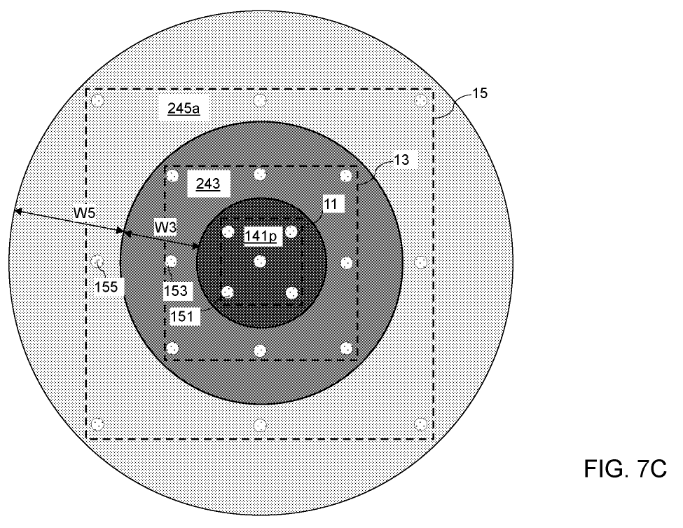

FIGS. 7A-7D are various views of the die ejector 100 with a second alternative configuration according to one or more embodiments. In particular, FIG. 7A is a perspective view of the die ejector 100 with the second alternative configuration according to one or more embodiments. In FIG. 7A, the ejector cap 120, the ejector holder 130, and lower portions of the outer rod 145 and intermediate rod 143 are made transparent for ease of understanding. FIG. 7B is an exploded view of the ejector rods 140 in the die ejector 100 with a second alternative configuration according to one or more embodiments. FIG. 7C is a top-down view of the ejector pins 150 in the die ejector 100 with a second alternative configuration according to one or more embodiments.

As illustrated in FIG. 7A, the second alternative configuration may be substantially similar to the first alternative configuration in FIG. 5. However, in the second alternative configuration, the outer rod base plate top portion 245a may have a greater surface area (see FIG. 7C) allowing it to accommodate more ejector pins 150. Thus, the second alternative configuration may have a greater number of ejector pins 150 than the first alternative configuration. In at least one embodiment, the second alternative configuration of the die ejector 100 may have at least twenty-one (21) ejector pins 150. In particular, the second alternative configuration of the die ejector 100 may have at least five (5) inner ejector pins 151, at least eight (8) intermediate ejector pins 153 and at least eight (8) outer ejector pins 155 (see FIGS. 7B and 7C).

In particular, as illustrated in FIG. 7C, the width W5 of the outer rod base plate top portion 245a may be greater than a width W3 of the intermediate rod base plate 243. In at least one embodiment, the width W5 of the outer rod base plate top portion 245a may be at least 40% greater than a width W3 of the intermediate rod base plate 243.

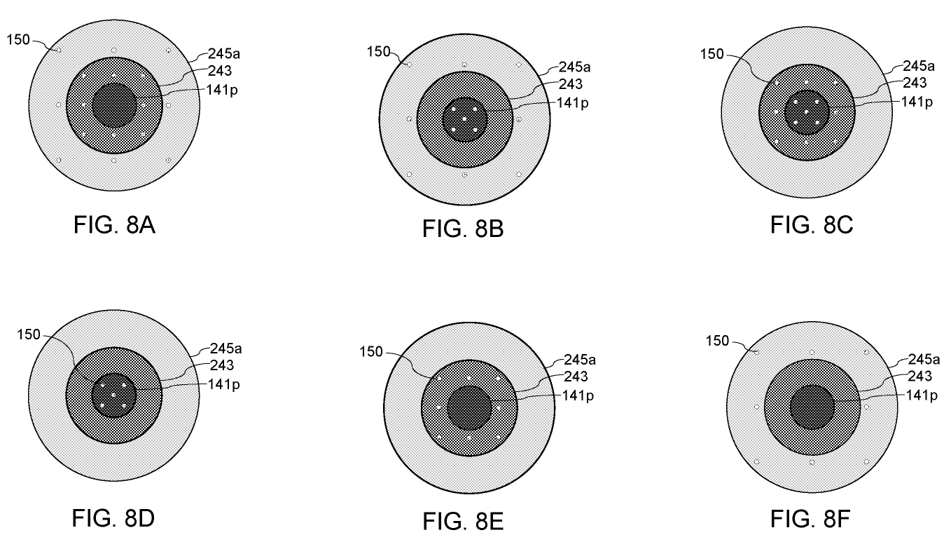

FIGS. 8A-8F are top-down views of the ejector pins 150 in the die ejector 100 with the second alternative configuration according to one or more embodiments. In particular, FIG. 8A is a top-down view of the ejector pins 150 having a first layout in the die ejector 100 with the second alternative configuration according to one or more embodiments. To produce the first layout, the ejector rods 140 may be configured so that the inner rod 141, intermediate rod 143 and outer rod 145 are all in an engaged status.

FIG. 8B is a top-down view of the ejector pins 150 having a second layout in the die ejector 100 with the second alternative configuration according to one or more embodiments. To produce the second layout, the ejector rods 140 may be configured so that the inner rod 141 and outer rod 145 are in an engaged status, but the intermediate rod 143 is in a disengaged status.

FIG. 8C is a top-down view of the ejector pins 150 having a third layout in the die ejector 100 with the second alternative configuration according to one or more embodiments. To produce the third layout, the ejector rods 140 may be configured so that the inner rod 141 and intermediate rod 143 are in an engaged status, but the outer rod 145 are in a disengaged status.

FIG. 8D is a top-down view of the ejector pins 150 having a fourth layout in the die ejector 100 with the second alternative configuration according to one or more embodiments. To produce the fourth layout, the ejector rods 140 may be configured so that the inner rod 141 is in an engaged (e.g., advanced) status, but the intermediate rod 143 and outer rod 145 are in a disengaged (e.g., not advanced) status.

FIG. 8E is a top-down view of the ejector pins 150 having a fifth layout in the die ejector 100 with the second alternative configuration according to one or more embodiments. To produce the fifth layout, the ejector rods 140 may be configured so that the intermediate rod 143 is in an engaged status, but the inner rod 141 and outer rod 145 are in a disengaged status.

FIG. 8F is a top-down view of the ejector pins 150 having a sixth layout in the die ejector 100 with the second alternative configuration according to one or more embodiments. To produce the sixth layout, the ejector rods 140 may be configured so that the outer rod 145 is in an engaged status, but the inner rod 141 and intermediate rod 143 are in a disengaged status.

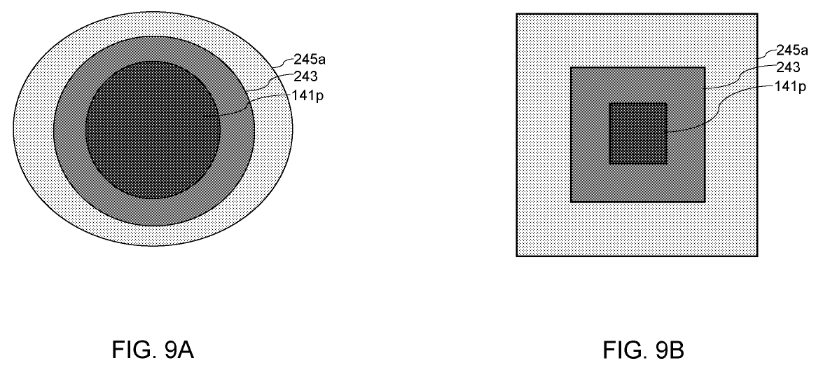

FIGS. 9A-9B are top-down views of the outer rod base plate top portion 245a, intermediate rod base plate 243 and inner rod proximal end 141p having alternative configurations in the die ejector 100 according to one or more embodiments. The alternative configurations may be implemented in the configuration of the die ejector 100 in FIG. 1A, the first alternative configuration of the die ejector in FIG. 5, and the second alternative configuration in FIG. 7A.

In particular, FIG. 9A is a top-down view of the outer rod base plate top portion 245a, intermediate rod base plate 243 and inner rod proximal end 141p having a first alternative configuration according to one or more embodiments. In the first alternative configuration, one or more of the outer rod base plate top portion 245a, intermediate base plate 243 and inner rod proximal end 141p may have an oval or elliptical shape in the top-down view.

FIG. 9B is a top-down view of the outer rod base plate top portion 245a, intermediate rod base plate 243 and inner rod proximal end 141p having a second alternative configuration according to one or more embodiments. In the second alternative configuration, one or more of the outer rod base plate top portion 245a, intermediate rod base plate 243 and inner rod proximal end 141p may have a square or rectangular shape in the top-down view.

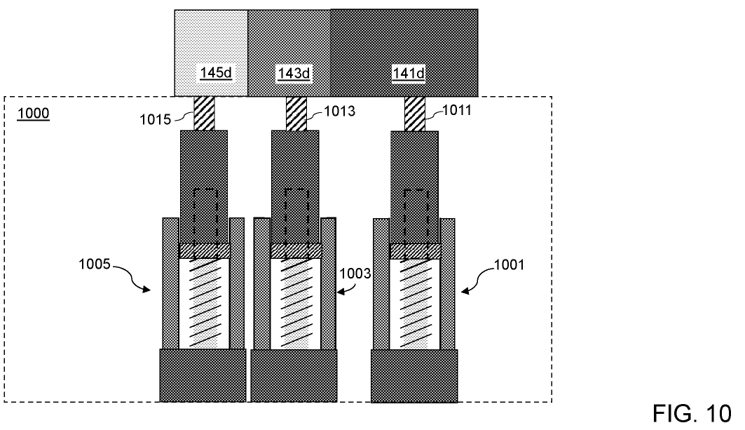

FIG. 10 is a schematic drawing of the drive mechanism 1000 for driving the ejector rods 140 in the die ejector 100 according to one or more embodiments. The drive mechanism 1000 may be included in the die ejector 100. Other types of drive mechanisms are within the contemplated scope of disclosure.

As illustrated in FIG. 10, the drive mechanism 1000 may include an inner rod linear actuator 1001 for driving the inner rod 141. The inner rod linear actuator 1001 may be connected to the inner rod distal end 141d by an inner rod connector 1011. The drive mechanism 1000 may also include an intermediate rod linear actuator 1003 for driving the intermediate rod 143. The intermediate rod linear actuator 1003 may be connected to the intermediate rod distal end 143d by an intermediate rod connector 1013. The drive mechanism 1000 may also include an outer rod linear actuator 1005 for driving the outer rod 145. The outer rod linear actuator 1005 may be connected to the outer rod distal end 145d by an outer rod connector 1015. With this configuration, the drive mechanism 1000 may allow for independent control of the forward movement (e.g., engaging movement) and backward movement (e.g., disengaging movement) for each of the inner rod 141, intermediate rod 143 and outer rod 145.

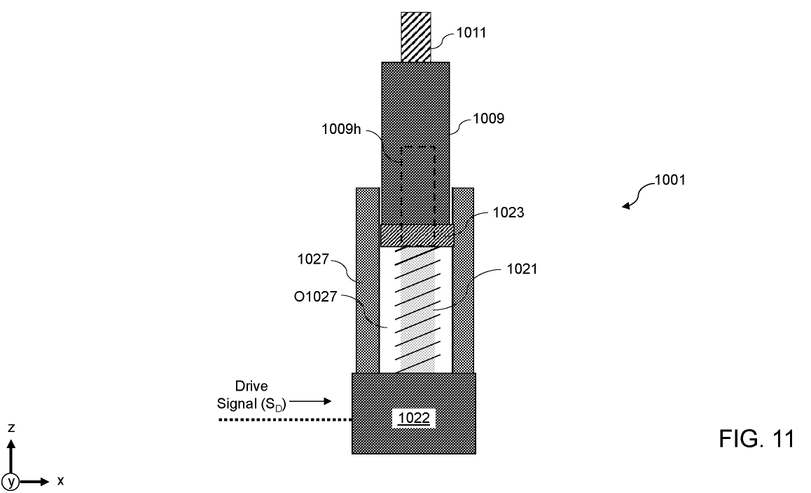

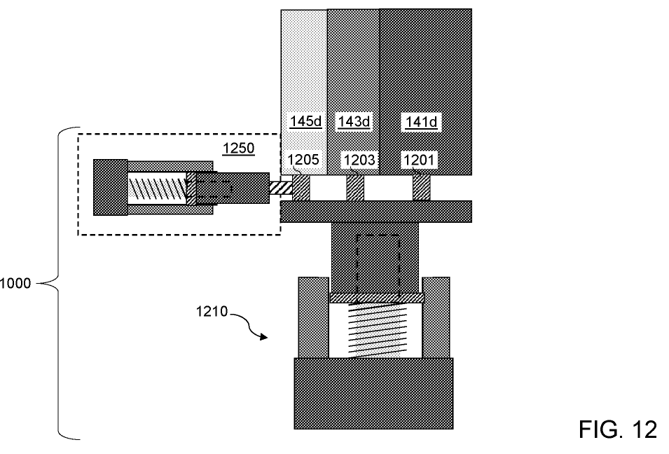

FIG. 11 is a schematic drawing of the inner rod linear actuator 1001 in the drive mechanism 1000 in the die ejector 100 according to one or more embodiments. The intermediate rod linear actuator 1003 and outer rod linear actuator 1005 may have a configuration similar to that of the inner rod linear actuator 1001.

As illustrated in FIG. 11, the inner rod linear actuator 1001 may include a hollow drive chamber 1027, threaded shaft 1021 in an opening O1027 in the hollow drive chamber 1027, and an electric motor 1022 attached to the threaded shaft 1021. The threaded shaft 1021 may extend in the z-direction in the opening O1027. The electric motor 1022 may be fixed at a lower end of the opening O1027. The electric motor 1022 may rotate the threaded shaft 1021 clockwise or counterclockwise.

The inner rod linear actuator 1001 may also include a nut 1023 that is fixed to an upper end of the opening O1027. The nut 1023 may also be slidably fixed to an inner sidewall of the hollow drive chamber 1027. In at least one embodiment, the sidewall of the hollow drive chamber 1027 may include one or more grooves extending up and down along the inner sidewall and a portion of the nut 1023 may be located in the grooves.

The inner rod linear actuator 1001 may also include a pillar 1009 attached to the nut 1023. The pillar 1009 may include a hole 1009h and the threaded shaft 1021 may move without restriction into and out of the hole 1009h. An upper end of the pillar 1009 may be attached to the inner rod connector 1011 which is connected to the inner rod distal end 141d.

A drive signal SD (drive voltage) for driving the electric motor 1022 may be transmitted by wire or wirelessly to the electric motor 1022. Depending on the drive signal, the electric motor 1022 may drive the threaded shaft 1021 to rotate clockwise or counterclockwise causing the nut 1023 to ride up and down the threads of the threaded shaft 1021 in the corresponding direction. This may provide an extension and retraction capability to the pillar 1009.

Thus, for example, by rotating the threaded shaft 1021 clockwise the pillar 1009 may be retracted into the opening O1027 so that the inner rod 141 may be withdrawn into a disengaged status. By rotating the threaded shaft 1021 counterclockwise the pillar 1009 may be extended out of the opening O1027. This may cause the pillar 1009 to advance the inner rod 141 forward into an engaged position. Conversely, by rotating the threaded shaft 1021 clockwise the pillar 1009 may be pulled back into the opening O1027. This may cause the pillar 1009 to retreat the inner rod 141 backward into a disengaged position. One of skill in the art would understand that the threaded shaft may be configured to advance under a clockwise rotation and retreat under a counter clockwise rotation as well.

FIG. 12 is a schematic drawing of the drive mechanism 1000 having an alternative configuration in the die ejector 100 according to one or more embodiments. In the alternative configuration, the drive mechanism 1000 may have a combination linear actuator 1210. The combination linear actuator 1210 may be configured to drive each of the inner rod 141, intermediate rod 143 and outer rod 145. The combination linear actuator 1210 may have a structure and function similar to the inner rod linear actuator 1001 in FIG. 11.

The drive mechanism 1000 may also include a blocking mechanism 1250 for blocking the combination linear actuator 1210 from advancing one or more of the inner rod 141, intermediate rod 143 or outer rod 145. In at least one embodiment, the blocking mechanism 1250 may include a linear actuator design. Other designs for the blocking mechanism are within the contemplated scope of disclosure.

The combination linear actuator 1210 may be connected to the inner rod distal end 141d by a releasable connector 1201, connected to the intermediate rod distal end 143d by a releasable connector 1203, and connected to the outer rod distal end 145d by a releasable connector 1205. The blocking mechanism 1250 may block the combination linear actuator 1210 from moving the inner rod 141 by releasing the releasable connector 1201. The blocking mechanism 1250 may block the combination linear actuator 1210 from moving the intermediate rod 143 by releasing the releasable connector 1203. The blocking mechanism 1250 may block the combination linear actuator 1210 from moving the outer rod 145 by releasing the releasable connector 1205. Other methods of using the combination linear actuator 1210 with the blocking mechanism are within the contemplated scope of disclosure.

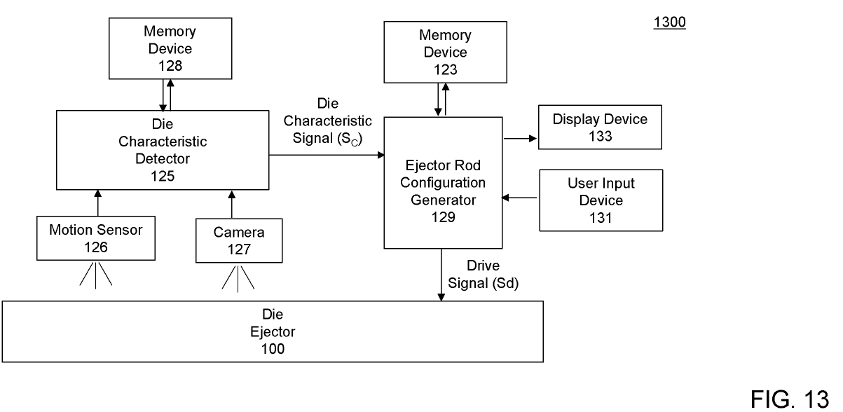

FIG. 13 is a schematic block diagram of a die ejector system 1300 according to one or more embodiments. As illustrated in FIG. 13, the die ejector system 1300 may include a die characteristic detector 125. The die characteristic detector 125 may be configured to detect a characteristic (e.g., size, shape, weight, etc.) of a semiconductor die (target die) that is the target of a die pickup process.

The die characteristic detector 125 may be mounted, for example, on or near an upper surface of the die ejector 100. The die ejector system 1300 may also include a motion sensor 126 in communication with the die characteristic detector 125. The motion sensor 126 may detect motion on the upper surface of the die ejector 100. In particular, the motion sensor 126 may detect the placement of the target die on the upper surface of the die ejector 100.

The die ejector system 1300 may also include a camera 127 in communication with the die characteristic detector 125. The camera 127 may include a still camera or video camera. The die characteristic detector 125 may activate the camera upon the motion sensor detecting a motion on the upper surface of the die ejector 100. The camera 127 may capture an image of the target die that has been placed on the upper surface of the die ejector 100. The camera 127 may generate image data and transmit the image data to the die characteristic detector 125.

The die characteristic detector 125 may include a processor such as a central processing unit (CPU). The die characteristic detector 125 may receive the image data from the camera 127 and perform one or more operations on the image data. The die ejector system 1300 may include a memory device 128 coupled to the die characteristic detector 125. The memory device 128 may include, for example, random access memory (RAM), read-only memory (ROM), etc. The die characteristic detector 125 may store the image data and other data (e.g., history data; software applications) in the memory device 128. In at least one embodiment, the die characteristic detector 125 may perform one or more operations on the image data to determine a characteristic of the target die. The die characteristic detector 125 may use other data (e.g., reference data stored in the memory device 128) in addition to the image data to determine a characteristic of the target die. Based on a result of the operations performed by the die characteristic detector 125 on the image data, the die characteristic detector 125 may generate a die characteristic signal Sc.

The die ejector system 1300 may further include an ejector rod configuration generator 129. The ejector rod configuration generator 129 may be configured to generate an ejector rod configuration for configuring the plurality of ejector rods 140 (see FIG. 1A) based on the die characteristic signal Sc (e.g., the detected characteristic of the target die). The die characteristic detector 125 may transmit the die characteristic signal Sc to the ejector rod configuration generator 129.

The die characteristic detector 125 may transmit the die characteristic signal Sc to the die ejector system 1300 by a wired connection. Alternatively or additionally, the die characteristic detector 125 may include a wireless transmitter for wirelessly transmitting the drive signal (Sd). In this embodiment, the die characteristic detector 125 may be wirelessly connected to the ejector rod configuration generator 129 by a near-field wireless communication technology. Examples of near-field wireless communications technology may include Bluetooth®, Zigbee®, Wi-Fi®, etc. Other near-field wireless communications technologies may be implemented. That is, the die characteristic signal Sc may be a wireless signal which may eliminate the need for the wired connection between the die characteristic detector 125 and the ejector rod configuration generator 129.

The ejector rod configuration generator 129 may include a processor such as a central processing unit (CPU). The ejector rod configuration generator 129 may perform one or more operations on the values of the die characteristic signal Sc. The ejector rod configuration generator 129 may use other data in addition to the die characteristic signal Sc to generate an ejector rod configuration in the die ejector 100.

The die ejector system 1300 may also include a second memory device 123 such as random access memory (RAM), read-only memory (ROM), etc. The second memory device 123 may be communicatively coupled to the ejector rod configuration generator 129. The ejector rod configuration generator 129 may access the second memory device 123 to store data used or generated by the operations performed on the die characteristic signal Sc. In at least one embodiment, the memory device 123 may store instructions to be executed by the ejector rod configuration generator 129. In at least one embodiment, the second memory device 123 may store data to be used by the ejector rod configuration generator 129 in executing the instructions. In at least one embodiment, the second memory device 123 may store other data such as history data that may be generated by the ejector rod configuration generator 129.

The second memory device 123 may store data and/or instructions in the form of a lookup table and/or a calculation table. These tables may be accessed by the ejector rod configuration generator 129 and used by the ejector rod configuration generator 129 to execute instructions or control various operations in the die ejector system 1300. In some embodiments, the memory device 128 may also serve as the second memory device 123.

The die ejector system 1300 may also include an input device 131 (e.g., keyboard, mouse, touchpad, etc.) and a display device 133 (e.g., a light emitting diode (LED) display unit, a liquid crystal display (LCD) display unit, etc.). The ejector rod configuration generator 129 may generate a display to be displayed on the display device 133. The display device 133 may also generate a display based on an input by the input device 131. An operator (e.g., user) may use the input device 131 to input an operating instruction to the ejector rod configuration generator 129. The operator may also use the input device 131 to manually input an ejector rod configuration to the ejector rod configuration generator 129. The operator may also use the input device 131 to input software updates, adjust an operating condition (e.g., coplanarity tolerance), etc. The operator may also use the input device 131 to manually input a size or shape of the die, in which case the ejector rod configuration generator 129 may generate an ejector rod configuration based on the user input.

The ejector rod configuration generator 129 may generate a drive signal Sd (e.g., voltage signal) based on the die characteristic signal Sc (or based on a user input). The die ejector 100 may configure the inner rod 141, intermediate rod 143 and outer rod 145 based on the drive signal Sd. The ejector rod configuration generator 129 may transmit the drive signal Sd to the die ejector 100 by a wired connection or wireless connection. It should be noted that by configuring the ejector rods 140, the die ejector 100 may be configuring the ejector pins 150 on the ejector rods. Thus, by configuring the ejector rods 140 based on a characteristic of the die, the die ejector 100 may also be configuring the ejector pins 150 based on a characteristic of the die.

In particular, the drive signal Sd may be transmitted to the drive mechanism 1000 in the die ejector 100. In at least one embodiment, the drive signal Sd may be transmitted to the motor 1022 of a linear actuator (e.g., inner rod linear actuator 1001, intermediate rod linear actuator 1003, outer rod linear actuator 1005,). The motor 1022 may be driven by the drive signal Sd to engage or disengage (e.g., advance or withdraw) one or more of the inner rod 141, intermediate rod 143 and outer rod 145. Alternatively, referring to the alternative configuration of the drive mechanism 1000 in FIG. 12, the drive signal Sd may be transmitted to the combination linear actuator 1210 and the blocking mechanism 1250 to engage or disengage (e.g., advance or withdraw) one or more of the inner rod 141, intermediate rod 143 and outer rod 145.

Referring to FIGS. 1A-13, a die ejector 100 may include an ejector cap 120, an ejector holder 130 in the ejector cap 120, a plurality of ejector rods 140 in the ejector holder 130, wherein the plurality of ejector rods 140 may be independently engaged, and a plurality of ejector pins 150 on the plurality of ejector rods 140.

In one embodiment, the plurality of ejector rods 140 may include an inner rod 141 having a solid cylindrical shape, an outer rod 145 surrounding the inner rod 141 and having a hollow cylindrical shape, and an intermediate rod 143 disposed between the inner rod 141 and outer rod 145 and having a hollow cylindrical shape. In one embodiment, the inner rod 141, the outer rod 145 and the intermediate rod 143 may be concentrically arranged. In one embodiment, the intermediate rod 143 may slidably contact the inner rod 141 and the outer rod 145. In one embodiment, the ejector holder 130 may slidably contact an inner sidewall 122 of the ejector cap 120. In one embodiment, the ejector holder 130 may include an ejector holder bottom plate 136 and a proximal end 141p of the inner rod 141, a proximal end 145p of the outer rod 145 and a proximal end of the intermediate rod 143p may be inserted into an opening 136o in the ejector holder bottom plate 136. In one embodiment, the outer rod 145 may slidably contact the ejector holder bottom plate 136 around the opening 136o. In one embodiment, the die ejector 100 may further include an intermediate rod base plate 243 attached to the proximal end 143p of the intermediate rod 143, and an outer rod base plate 245 attached to the proximal end 145p of the outer rod 145. In one embodiment, the outer rod base plate 245 may include a recessed portion 245r and the intermediate rod base plate 243 may be configured to be nested in the recessed portion 245r of the outer rod base plate 245. In one embodiment, the outer rod base plate 245 may slidably contact an inner sidewall 132 of the ejector holder 130. In one embodiment, the plurality of ejector pins 150 may include a plurality of inner ejector pins 151 on the proximal end 141p of the inner rod 141, a plurality of intermediate ejector pins 153 on the intermediate rod base plate 243, and a plurality of outer ejector pins 155 on the outer rod base plate 245. In one embodiment, the ejector holder 130 may include an ejector holder top plate 134 opposite the ejector holder bottom plate 136, and the ejector holder top plate 134 may include a plurality of ejector holder openings 134o configured to receive the plurality of inner ejector pins 151, the plurality of intermediate ejector pins 153 and the plurality of outer ejector pins 155. In one embodiment, the ejector cap 120 may include an ejector cap top plate 124 adjacent the ejector holder top plate 134, and the ejector cap top plate 124 may include a plurality of ejector cap openings 124o configured to receive the plurality of inner ejector pins 151, the plurality of intermediate ejector pins 153 and the plurality of outer ejector pins 155.

Referring again to FIGS. 1A-13, a method of performing semiconductor die pick-up may include placing a semiconductor die on a die ejector 100 including a plurality of ejector rods 140 and a plurality of ejector pins 150 on the plurality of ejector rods 140, wherein the plurality of ejector rods 140 may be independently engaged, generating an ejector rod configuration so that the plurality of ejector pins 150 have a configuration based on the semiconductor die, advancing the plurality of ejector rods 140 based on the ejector rod configuration so that the plurality of ejector pins 150 contact the semiconductor die, and lifting the semiconductor die off the plurality of ejector pins 150.

In one embodiment, the die ejector 100 may further include an ejector cap 120 and an ejector holder 130 in the ejector cap 120, the plurality of ejector rods 140 may be in the ejector holder 130, and the advancing of the plurality of ejector rods 140 may include advancing the plurality of ejector rods 140 in the ejector holder 130. In one embodiment, the method may further include placing a tip holder on the semiconductor die prior to generating of the ejector rod configuration, and advancing the ejector holder 130 inside the ejector cap 120. In one embodiment, the generating of the ejector rod configuration may include detecting a characteristic of the semiconductor die, and generating the ejector rod configuration based on the characteristic of the semiconductor die. In one embodiment, the detecting of the characteristic of the semiconductor die may include at least one of detecting a size of the semiconductor die with a camera, detecting a shape of the semiconductor die with a camera, or inputting at least one of a size or shape of the semiconductor die by a user.

Referring again to FIGS. 1A-13, a die ejecting system 1300 may include a die ejector 100 including a plurality of ejector rods 140 and a plurality of ejector pins 150 on the plurality of ejector rods 140, wherein the plurality of ejector rods 140 may be independently engaged, a die characteristic detector configured to detect a characteristic of a semiconductor die to be ejected by the die ejector 100, and an ejector rod configuration generator configured to generate an ejector rod configuration for configuring the plurality of ejector rods 140 based on the detected characteristic of the semiconductor die 10.

In one embodiment, the die ejector 100 in the die ejecting system 1300 may further include an ejector cap 120, and an ejector holder 130 in the ejector cap 120, wherein the plurality of ejector rods 140 may be located in the ejector holder 130.

Various embodiment die ejectors are disclosed herein that provide for a variable configuration of a plurality of ejector rods and a plurality of ejector pins disposed on the plurality of ejector rods to provide a variable configuration depending on a configuration of the semiconductor die that is the target of a PNP process. Various embodiment die ejectors may include a plurality of rods or rod sets that may be independently engaged. In this manner the various embodiments disclosed herein provide advantages in that the disclosed embodiments may not require a tool conversion for different products. Thus, one or more embodiments may help to ensure that semiconductor processing equipment is suitable for a variety of products may be used in the absence of a tool conversion. One or more embodiments may, therefore, improve a tool conversion ratio to achieve a reduction in tool changeover times for multi-layer production. The one or more embodiments may also help to ensure that the dies (e.g., especially thin dies) are free of chipping defects in a die stacking process. In this manner, various embodiments die ejectors disclosed herein may include a new ejector structure design for multiple product production. The various embodiments die ejectors may include a controllable multiple layout ejector. The various embodiments die ejectors may also provide for multiple layouts in one ejector.

The various embodiments die ejectors may provide several advantages/benefits. In particular, the various embodiment die ejectors may improve equipment available time. The various embodiments die ejectors may also provide an improved process window. The various embodiments die ejectors may also help to reduce a number of void defects, and therefore may also provide improved reliability and product yield.

The foregoing outlines features of several embodiments or examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments or examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A die ejector, comprising:
an ejector cap;
an ejector holder in the ejector cap;
a plurality of ejector rods in the ejector holder, wherein the plurality of ejector rods are independently engaged; and
a plurality of ejector pins on the plurality of ejector rods.

2. The die ejector of claim 1, wherein the plurality of ejector rods comprise:
an inner rod having a solid cylindrical shape;
an outer rod surrounding the inner rod and having a hollow cylindrical shape; and
an intermediate rod disposed between the inner rod and the outer rod and having a hollow cylindrical shape.

3. The die ejector of claim 2, wherein the inner rod, the outer rod and the intermediate rod are concentrically arranged.

4. The die ejector of claim 2, wherein the intermediate rod slidably contacts the inner rod and the outer rod.

5. The die ejector of claim 1, wherein the ejector holder slidably contacts an inner sidewall of the ejector cap.

6. The die ejector of claim 2, wherein the ejector holder comprises an ejector holder bottom plate and a proximal end of the inner rod, a proximal end of the outer rod and a proximal end of the intermediate rod are inserted into an opening in the ejector holder bottom plate.

7. The die ejector of claim 6, wherein the outer rod slidably contacts the ejector holder bottom plate around the opening.

8. The die ejector of claim 6, further comprising:
an intermediate rod base plate attached to the proximal end of the intermediate rod; and
an outer rod base plate attached to the proximal end of the outer rod.

9. The die ejector of claim 8, wherein the outer rod base plate includes a recessed portion and the intermediate rod base plate is configured to be nested within the recessed portion of the outer rod base plate.

10. The die ejector of claim 8, wherein the outer rod base plate slidably contacts an inner sidewall of the ejector holder.

11. The die ejector of claim 8, wherein the plurality of ejector pins comprises:
a plurality of inner ejector pins on the proximal end of the inner rod;
a plurality of intermediate ejector pins on the intermediate rod base plate; and
a plurality of outer ejector pins on the outer rod base plate.

12. The die ejector of claim 11, wherein the ejector holder comprises an ejector holder top plate opposite the ejector holder bottom plate, and the ejector holder top plate comprises a plurality of ejector holder openings configured to receive the plurality of inner ejector pins, the plurality of intermediate ejector pins and the plurality of outer ejector pins.

13. The die ejector of claim 12, wherein the ejector cap comprises an ejector cap upper plate adjacent the ejector holder top plate, and the ejector cap upper plate comprises a plurality of ejector cap openings configured to receive the plurality of inner ejector pins, the plurality of intermediate ejector pins and the plurality of outer ejector pins.

14. A die ejector system, comprising:
a die ejector including a plurality of ejector rods and a plurality of ejector pins on the plurality of ejector rods, wherein the plurality of ejector rods are independently engaged;
a die characteristic detector configured to detect a characteristic of a semiconductor die to be ejected by the die ejector; and
an ejector rod configuration generator configured to generate an ejector rod configuration for configuring the plurality of ejector rods based on the detected characteristic of the semiconductor die.

15. The die ejector system of claim 14, wherein the die ejector further comprises:
an ejector cap; and
an ejector holder in the ejector cap, wherein the plurality of ejector rods are located in the ejector holder.

16. A drive mechanism for a die ejector, comprising:
a plurality of linear actuators, wherein each of the plurality of linear actuators is configured to independently drive a corresponding one of a plurality of ejector rods in the die ejector.

17. The drive mechanism of claim 16, wherein the plurality of linear actuators comprises one or more of an inner rod linear actuator, an intermediate rod linear actuator, or an outer rod linear actuator.

18. The drive mechanism of claim 17, wherein one or more of the inner rod linear actuator, the intermediate rod linear actuator, or the outer rod linear actuator comprises a threaded shaft, an electric motor configured to rotate the threaded shaft, or a nut on the threaded shaft configured to move along the threaded shaft in response to rotation of the threaded shaft.

19. The drive mechanism of claim 16, further comprising a plurality of connectors, wherein one or more of the plurality of connectors connects one of the plurality of linear actuators to a distal end of a respective one of the plurality of ejector rods.

20. The drive mechanism of claim 16, wherein the plurality of linear actuators comprises a combination linear actuator configured to drive one or more of the plurality of ejector rods, wherein a blocking mechanism is configured to block the combination linear actuator from advancing the one or more of the plurality of ejector rods.
